(19) United States
(12) Patent Application Publication
(10) Pub. No.: US 2017/0372339 A1
(43) Pub. Date: Dec. 28, 2017

(54) SYSTEM AND METHOD FOR SURVEYING ASSET INVENTORY OF LIGHTING FIXTURE INFRASTRUCTURE

(71) Applicant: The Will Group, Wheaton, IL (US)

(72) Inventor: Joshua Davis, Chicago, IL (US)

(21) Appl. No.: 15/195,946

(22) Filed: Jun. 28, 2016

(51) Int. Cl. G06Q 30/02; G06F 17/30; G06F 3/0484

(52) U.S. Cl. CPC G06Q 30/0203; G06F 3/0484; G06F 17/30241

(57) ABSTRACT

An apparatus includes a processor, and a database configured to store asset inventory survey data of at least one asset owner. The processor is configured to execute a GUI through an electronic display. The GUI includes a geographical map, a geospatial pin on the map at a location corresponding to a location field value of an asset record in the database, and at least one content control configured to add or update at least one corresponding field value in the database using content inputted to the at least one content control. The processor is configured to determine that a user associated with a particular asset owner from among the at least one asset owner is authorized to access asset inventory survey data of the particular asset owner. The processor is configured to: based on the determination, display the asset inventory survey data of the particular asset owner in the GUI.

### TECHNICAL FIELD

The present application relates generally to information systems and, more specifically, to an assert inventory survey system and method of operating the same.

### BACKGROUND

Various entities, such as electric utility providers or municipalities, own lighting infrastructure and associated assets. In order to maintain these assets, maintenance personnel needs to not only know the location of the asset upon which to perform work, but also an identification of the asset. In the case of pole-mounted lighting fixture access to the lighting fixture could be affected by other equipment mounted to the same pole, or could be hindered by vegetation. Some of these entities do not have an inventory of the assets owned. Some of these entities do not have information about the location and/or condition of the assets that are in service in the field. Some of these entities have a partial list of assets owned with only a street address as the location of the assets. As streets can be nameless, renamed, relocated, resized, or removed, a street address does not provide a timeless geographical location. Also, as a single street address could apply to a large geographical area, maintenance personnel may experience difficulty locating a particular pole or a pole-mounted asset upon which to perform work, even if the maintenance personnel knows the street address.

### SUMMARY OF THE INVENTION

In a first embodiment, an apparatus includes a processor, and a database configured to store asset inventory survey data of at least one asset owner. The processor is configured to execute a graphical user interface (GUI) through an electronic display. The GUI includes a geographical map, a geospatial pin on the map at a location corresponding to a location field value of an asset record in the database, and at least one content control configured to add or update at least one corresponding field value in the database using content inputted to the at least one content control. The processor is configured to determine that a user associated with a particular asset owner from among the at least one asset owner is authorized to access asset inventory survey data of the particular asset owner. The processor is configured to: based on the determination, display the asset inventory survey data of the particular asset owner in the GUI.

In a second embodiment, a non-transitory computer readable medium embodying a computer program is provided. The computer program includes computer readable program code that, when executed by processing circuitry, causes the processing circuitry to: store, in a database, asset inventory survey data of at least one asset owner. The computer program includes computer readable program code that, when executed by processing circuitry, causes the processing circuitry to: execute a graphical user interface (GUI) through an electronic display. The GUI includes: a geographical map, a geospatial pin on the map at a location corresponding to a location field value of an asset record in the database, and at least one content control corresponding to at least one field value in the database. The computer program includes computer readable program code that, when executed by processing circuitry, causes the processing circuitry to: add or update the at least one field value using content inputted to the at least one content control. The computer program includes computer readable program code that, when executed by processing circuitry, causes the processing circuitry to: determine that a user associated with a particular asset owner from among the at least one asset owner is authorized to access asset inventory survey data of the particular asset owner. The computer program includes computer readable program code that, when executed by processing circuitry, causes the processing circuitry to: based on the determination, display the asset inventory survey data of the particular asset owner in the GUI.

In a third embodiment, a method includes storing, in a database, asset inventory survey data of at least one asset owner. The method includes executing a graphical user interface (GUI) through an electronic display. The GUI includes: a geographical map, a geospatial pin on the map at a location corresponding to a location field value of an asset record in the database, and at least one content control corresponding to at least one field value in the database. The method includes adding or updating the at least one field value using content inputted to the at least one content control. The method includes determining that a user associated with a particular asset owner from among the at least one asset owner is authorized to access asset inventory survey data of the particular asset owner. The method includes: based on the determination, displaying the asset inventory survey data of the particular asset owner in the GUI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example computing system in which various embodiments of this disclosure may be implemented;

FIG. 2 illustrates an example processing device in a computing system according to this disclosure;

FIG. 3 illustrates an example survey device in a computing system according to this disclosure;

FIGS. 4A and 4B illustrate a user equipment displaying a user interface generated by the survey tool according to this disclosure;

FIG. 5 illustrates an initial logged-in screen according to this disclosure;

FIG. 6 illustrates a display screen of a GUI according to an installation function of the survey tool according to this disclosure;

FIG. 7 illustrates a display screen of a GUI according to the punch list function of the survey tool according to this disclosure;

FIG. 8 illustrates a display screen of a GUI according to the “New Asset” function of the survey tool according to this disclosure;

FIG. 9 illustrates an example location section of a GUI generated by the survey tool according to this disclosure;

FIG. 10 illustrates an example equipment section of a GUI generated by the survey tool according to this disclosure;

FIG. 11 illustrates an example of display screen of a section of obstructions flags and a section of review flags according to this disclosure;

FIG. 12 illustrates a photo section according to this disclosure;

FIG. 13 illustrates a status section of a GUI according to the “New Asset” function according to this disclosure;

FIG. 14 illustrates a display screen showing a notes section of the GUI according to the “New Asset” function of the survey tool according to this disclosure;

FIG. 15 illustrates a display screen of a comma separated value (CSV) data export of multiple records from the asset inventory survey database according to this disclosure;

FIG. 16 illustrates a display screen of a Keyhole Markup Language (KML) data export of multiple records from the asset inventory survey database according to this disclosure;

FIG. 17 illustrates various KML and CSV exports by specific criteria according to this disclosure; and

FIG. 18 illustrates a method for building an asset inventory survey database and generating a graphical user interface (GUI) including a display screen of information in the asset inventory survey database according to this disclosure.

### DETAILED DESCRIPTION

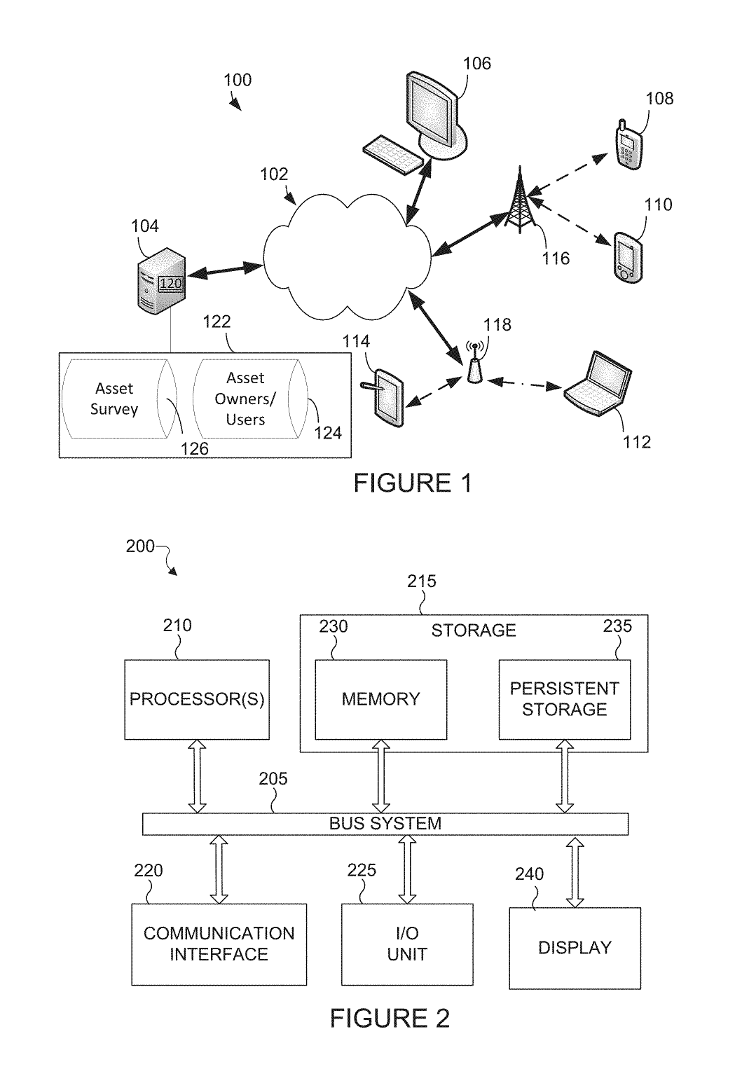

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system.

Embodiments of the present disclosure provide a web-based application of the survey tool configured to perform real-time inventory identification, recordation, and management in accordance with aspects of the present disclosure. In certain embodiments, the survey device or system is configured to communicate with one or more survey device in one or more remote geographical locations to obtain real-time status information regarding one or more assets located remotely from a central operating facility. In certain embodiments, the survey device or system updates, in real-time, an asset inventory survey database that can be further accessed by one or more operator terminals that are either co-located or remotely located from the asset inventory survey database.

FIG. 1 illustrates an example computing and communication system 100 in which various embodiments of this disclosure may be implemented. The embodiment of the computing system 100 shown in FIG. 1 is for illustration only. Other embodiments of the computing system 100 could be used without departing from the scope of this disclosure.

As shown in FIG. 1, the system 100 includes a network 102, which facilitates communication between various components in the system 100 on one or more communication channels. The network 102 may communicate Internet Protocol (IP) packets, frame relay frames, or other information between network addresses. The network 102 may include one or more local area networks (LANs): metropolitan area networks (MANs); wide area networks (WANs); all or a portion of a global network, such as the Internet; or any other communication system or systems at one or more locations.

The network 102 facilitates communications between one or more servers 104 and various client devices 106-114. Each of the servers 104 includes any suitable computing or processing device that can provide computing services for one or more client devices. Each of the servers 104 could, for example, include one or more processing devices, one or more memories storing instructions and data, and one or more network interfaces facilitating communication over the network 102. For example, one or more of the servers 104 may include processing circuitry for executing a web-based application for building an asset inventory survey database and generating a graphical user interface including a display screen of information in the asset inventory survey database, as discussed in greater detail below. That is, the servers 104 include a survey tool 120 that includes the web-based application, which when executed, builds the asset inventory survey database 120 (described in detail below). In certain embodiments, a server 104 stores the asset inventory survey database 122, and in other embodiments, the server 104 is coupled to a memory that stores the asset inventory survey database 122.

Each client device 106-114 represents any suitable computing or processing device that interacts with at least one server or other computing device(s) over the network 102. As will be discussed in greater detail below, the client devices 106-114 receive user input (e.g., user authentication information or menu selections) and may include processing circuitry for providing inputs (e.g., via a web browser) to the web-based application of the survey tool 120, which uses the inputs for building an asset inventory survey database and generating a graphical user interface (GUI) including a display screen of information in the asset inventory survey database 122. As will be discussed in greater detail below, the client devices 106-114 control an electronic display to display a GUI including a display screen of information of the asset inventory survey database 122 received from the server 104. Each of the client devices 106-114 either includes or is connected to a display device for display of the GUI including a display screen of information in the asset inventory survey database 122. In this example, the client devices 106-114 include a computer 106, a mobile telephone or smartphone 108, a personal digital assistant (PDA) 110, a laptop computer 112, and tablet computer 114. However, any other or additional client devices could be used in the communication system 100. In this example, some client devices 108-114 communicate indirectly with the network 102. For example, the client devices 108-110 communicate via one or more base stations 116, such as cellular base stations or eNodeBs. Also, the client devices 112-114 communicate via one or more wireless access points 118, such as IEEE 802.11 wireless access points. Note that these are for illustration only and that each client device could communicate directly with the network 102 or indirectly with the network 102 via any suitable intermediate device(s) or network(s).

According to this disclosure, the computing and communication system 100 includes the asset inventory survey database 122, which includes an asset owners database 124 as well as a of asset survey database 126. For example, the asset inventory survey database 122 can be a specifically configured database structure stored on a memory of one or more servers 104 coupled to the survey tool 120. The asset survey database 126 is configured to store records of lighting infrastructure and associated assets. The asset owner database 124 is configured to store records of asset owners, who own the lighting infrastructure and associated assets corresponding to the records stored in the asset survey database 126. The survey tool 120 generates a relationship link for each record in the asset survey database 126 to link to an asset owner record, such that each asset corresponds to its owner.

Also, the asset owner database 124 is configured to store records of users authorized to access the asset survey database 126. The survey tool 120 generates a relationship link for each asset owner record to link to a number of authorized user records. Each authorized user record contains user authentication information, such as a user name and password. The survey tool 120 enables the server 104 to determine that user authentication information received from a client device 106-114 matches the user authentication information in an authorized user record. In response to the determination, the survey tool 120 allows the server 104 to send that client device 106-114 information from the asset inventory survey database 122 that is linked to the same asset owner record that is linked the authorized user record containing the matched user authentication information.

For each asset owner record, an administrator of the web-based application of the survey tool 120 could select a number of authorized user records linked to that asset owner record, and in response, the survey tool 120 could generate the selected number of authorized user records linked to that asset owner record or could set the selected number of authorized user records as maximum number of authorized user records that can be linked to that asset owner record. The asset inventory survey database 122 is not limited to the databases 124-124, and could include additional databases.

Although FIG. 1 illustrates one example of a communication system 100, various changes may be made to FIG. 1. For example, the system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system. For example, an asset inventory survey database 122 can be provided to user devices (e.g., client device 1226-1215) without using the network 102, such as via a computer readable medium (e.g., flash memory storage device, compact disc, or the like).

FIG. 2 illustrates an example survey processing device 200 according to this disclosure. The embodiment of the survey processing device 200 is for illustration only. Other embodiments could be used without departing from the scope of the present disclosure. In certain embodiments, the survey processing device 200 is configured as one or more servers 104. In certain embodiments, the survey processing device 200 is included as a component in or coupled to one or more servers 104 or the client devices 106-114 in FIG. 1 to implement one or more embodiments of the present disclosure.

As shown in FIG. 2, the survey processing device 200 includes a bus system 205, which supports communication between at least one processor 210, at least one storage device 215, at least one communication interface 220, at least one input/output (I/O) unit 225, and a display 240.

The processor 210 executes instructions that may be loaded into a memory 230. The processor 210 can include any suitable number(s) and type(s) of processors or other devices in any suitable arrangement. Example types of processor 210 include microprocessors, microcontrollers, digital signal processors, field programmable gate arrays, application specific integrated circuits, and discreet circuitry. For example, the processor 210 can implement the web-based application of the survey tool 120 for building an asset inventory survey database and generating a graphical user interface including a display screen of information stored in the asset inventory survey database being implemented in hardware or by executing stored instructions that causes the processor 210 to perform the disclosed methods.

In certain embodiments, the processor 210 is a survey device (SD) processor configured to control operations of the web-based application of the survey tool 120 to perform inventory identification, recordation, and management in accordance with aspects of the present disclosure. In certain embodiments, the survey processing device 200 includes the processor 210 and a SD processor. The SD processor is configured to control the communication of survey data to and from the survey processing device 200 and to and from the asset inventory survey database 122. The SD processor controls communications with one or more client devices 106-114. The SD processor also is configured to manage authority levels of users accessing the web-based application of the survey tool 120. In certain embodiments, the SD processor is configured to communicate with one or more client devices 106-114 to control one or more aspects of the client devices 106-114, such as a display and display operations. The SD processor is configured to generate display information corresponding to specific geographic locations, receive update information regarding specific geographic locations, and edit one or more aspects of the asset inventory survey database 122.

The memory 230 and a persistent storage 235 are examples of storage devices 215, which represent any structure(s) capable of storing and facilitating retrieval of information (such as asset inventory survey data, program code, and/or other suitable information on a temporary or permanent basis). The memory 230 may represent a random access memory or any other suitable volatile or non-volatile storage device(s). For example, the memory 230 may contain instructions for building an asset inventory survey database and generating a graphical user interface including a display screen of information stored in the asset inventory survey database and/or may store all or portions of the asset inventory survey database 122 received by a server 104 or from one or more survey tools 120. The persistent storage 235 may contain one or more components or devices supporting longer-term storage of data, such as a read-only memory, hard drive, Flash memory, or optical disc. For example, the persistent storage 235 can contain asset survey data such as a location and manufacturer name of an asset.

The communication interface 220 supports communications with other systems or devices. For example, the communication interface 220 could include a network interface card, a cable modem, or a wireless transceiver facilitating communications over the network 102. The communication interface 220 can support communications through any suitable physical or wireless communication link(s).

The I/O unit 225 allows for input and output of data. For example, the I/O unit 225 can provide a connection for user input through a keyboard, mouse, keypad, touchscreen, or other suitable input device. The I/O unit 225 can also send output to the display 240, printer, or other suitable output device.

The survey processing device 200 further includes or is connected to a display 240, such as, the electronic displays of the various client devices 106-114. In one example embodiment, the survey processing device 200 is processing circuitry included in the various client devices 106-114 for a GUI including a display screen of information in the asset inventory survey database to be displayed. In another example embodiment, the survey processing device 200 can be the server 104 connected to an electronic display for a GUI including a display screen of information in the asset inventory survey database to be displayed and seen by an administrator of the web-based application of the survey tool 120. In yet another example embodiment, the survey processing device 200 can be a server 104 connected to an electronic display device over a network connection.

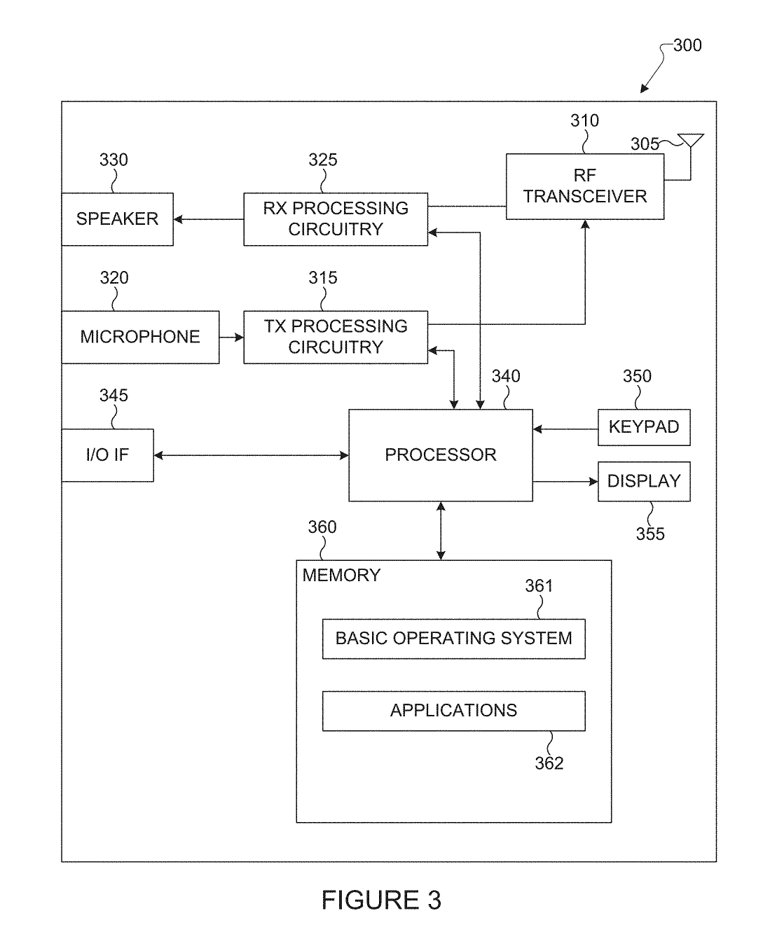

FIG. 3 illustrates an example survey device in a computing system according to this disclosure. The embodiment of the survey device 300 shown in FIG. 3 is for illustration only. Other embodiments could be used without departing from the scope of the present disclosure. The survey device 300 can be configured as a standalone device, as one or more of the client devices 106-114 or as an apparatus included in one or more of the client devices 106-114.

In certain embodiments, the survey device 300 includes an antenna 305, a radio frequency (RF) transceiver 310, transmit (TX) processing circuitry 315, a microphone 320, and receive (RX) processing circuitry 325. The survey device 300 also includes a speaker 330, a processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by another component in a system. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the basic OS program 361 stored in the memory 360 in order to control the overall operation of the client device 300. For example, the processor 340 could control the reception of forward channel signals and the transmission of reverse channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as operations for in response to providing inputs to the web-based application of the survey tool 120, controlling an electronic display to display a GUI including a display screen of information of the asset inventory survey database 122 received from the server 104. The processor 340 can move data into or out of the memory 360 as required by an executing process. In some embodiments, the processor 340 is configured to execute the applications 362 based on the OS program 361 or in response to signals received from external devices or an operator. For example, the applications 362 can include a client-device version of the web-based application of the survey tool 120 configured to perform inventory identification, recordation, and management in accordance with aspects of the present disclosure. The processor 340 is also coupled to the I/O interface 345, which provides the survey device 300 with the ability to connect to other devices such as laptop computers and handheld computers. The I/O interface 345 is the communication path between these accessories and the main controller 340.

The processor 340 is also coupled to the keypad 350 and the display unit 355. The operator of the survey device 300 can use the keypad 350 to enter data into the survey device 300. The display 355 may be a liquid crystal display or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

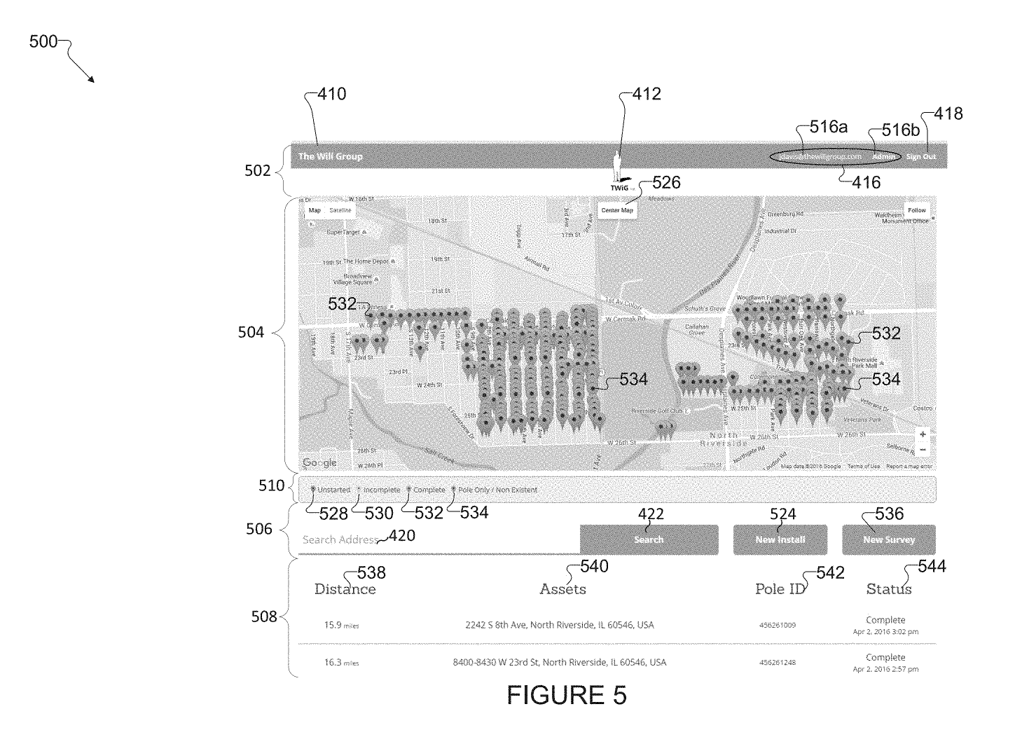

As described in more detail below, the survey device 300 includes a web browser, through which the survey device 300 receives user input indicating a Uniform Resource Locator (URL) to access the web-based application of the survey tool 120, and through which the survey device 300 receives user input including user authentication information in order for the web-based application of the survey tool 120 to unblock access to the asset inventory survey database 122. Once unblocked, the survey device 300 receives, from the web-based application of the survey tool 120, an initial logged-in screen 500 (described in detail with reference to FIG. 5). The survey device 300 receives subsequent user inputs indicating user selections, in response to which the survey device 300 receives, from the web-based application of the survey tool 120, other display screens generated by the web-based application of the survey tool 120.

Although FIGS. 2 and 3 illustrate examples of devices in a computing system, various changes may be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the survey device 300 configured as a mobile telephone or smartphone, client devices could be configured to operate as other types of mobile or stationary devices. In addition, as with computing and communication networks, client devices and servers can come in a wide variety of configurations, and FIGS. 2 and 3 do not limit this disclosure to any particular client device or server.

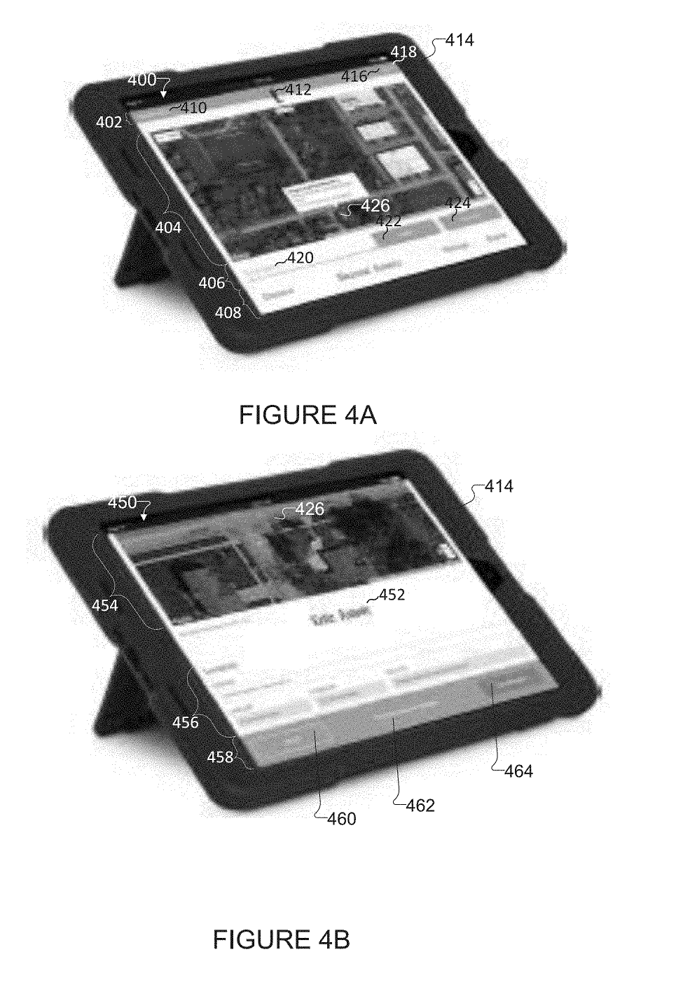

FIGS. 4A and 4B illustrate a survey device (SD) displaying a user interface generated by the web-based application of the survey tool 120 according to this disclosure. In the example, shown, the SD is a tablet computer 414, which could be the same as or similar to the tablet computer 114 of FIG. 1. In certain embodiments, the SD is configured as the tablet computer 414. In certain embodiments, table computer 414 includes the survey device 300.

The tablet 414 includes a display screen 400 configured to display a user interface. In certain embodiments, the display screen is a touch screen. The tablet 414 also includes one or more processors configured to control the display screen 400 and one or more functions of the tablet 414, such as operations for the SD including performing inventory identification, recordation, and management in accordance with aspects of the present disclosure.

As shown in the example shown in FIG. 4A, in response to a user input of a specific geographic location, such as an address, grid coordinate, global positioning system (GPS) coordinate, or the like, an SD processor within the table computer 414, retrieves information via one or more antenna and generates display information corresponding to the specific geographic location. The display 400 presents the display information including a graphic user interface (GUI) according to a “Search Address” function within the survey tool 120. The GUI according to a “Search Address” function includes heading section 402, a map section 404, a function menu section 406, and a tabular query results section 408. Additional sections could be included (i.e., displayed) in the GUI according to a “Search Address” function. Note, in certain embodiments, dimensions of the display 355 prevent the tablet computer 414 from displaying a single display screen containing the entire GUI according to a “Search Address” function, as such, a scroll function could be used. That is, the display screen 400 presents a partial portion of the entire GUI according to a “Search Address” function, and a scrolling operation, such as up, down, left or right, can cause the tablet computer 414 to display other portions.

In certain embodiments, the heading section 402 includes a horizontal bar underlying differently colored text including a display of a name 410, such as the name of the manufacturer of the web-based application of the survey tool 120, the name of the Asset Owner, or the name of the web-based application of the survey tool 120. The heading section 402 can include a trademark 412 associated with the web-based application of the survey tool 120, a user name 416 of the logged-in user authorized to access the asset survey database 126, and a “Sign Out” button 418.

The map section 404 displays a geographical map. The map section 404 is able to display other views of the geographical area, such as a geographical map view, a street level view, or an Earth view. As a specific non-limiting example, the map section 404 can include a map provided by GOOGLE® Maps or GOOGLE® Earth. As a specific example, in the display screen 400, the map section 404 shows a satellite view of a geographical area.

The survey tool 120 determines a reference point 426 for the map section 404. In certain embodiments, the reference point 426 is automatically determined, that is, without user interaction, as a center point of the geographical area currently displayed in the map section 404, or the reference point can be inputted by a user as a dropped-pin, street address, street intersection, or geographic coordinates (i.e., longitude and latitude coordinates). That is, the survey tool 120, with the tablet 414, or an SD processor within the table 414, calculates a center point of the geographical display based on the dimensions of the display screen 400 and the portion of the display information displayed within the display screen 400. When a scrolling operation is performed, the survey tool 120, with the tablet 414, or the SD processor within the tablet 414, recalculates a new center point of the geographical display based on the dimensions of the display screen 400 and the portion of the display information displayed within the display screen 400. In the specific display screen 400 shown, the survey tool 120 determines the reference point 426 according to a user-inputted street intersection. The survey tool 120 can generate a query request for the assets nearest the determined reference point 426. The survey tool 120 can run the query request on the asset inventory survey database 122, thereby generating query results that include asset records having a geographical information system (GIS) field value nearest the determined reference point 426. For example, the query results can be limited to asset records having a GIS field value within the geographical area currently displayed. As another example, the query results can be limited to asset records having a GIS field value that meets specific criteria, such as a within a specific radius, or within a specific driving distance of the reference point 426. The specific criteria can be user-selected or predetermined by default settings of the survey tool 120.

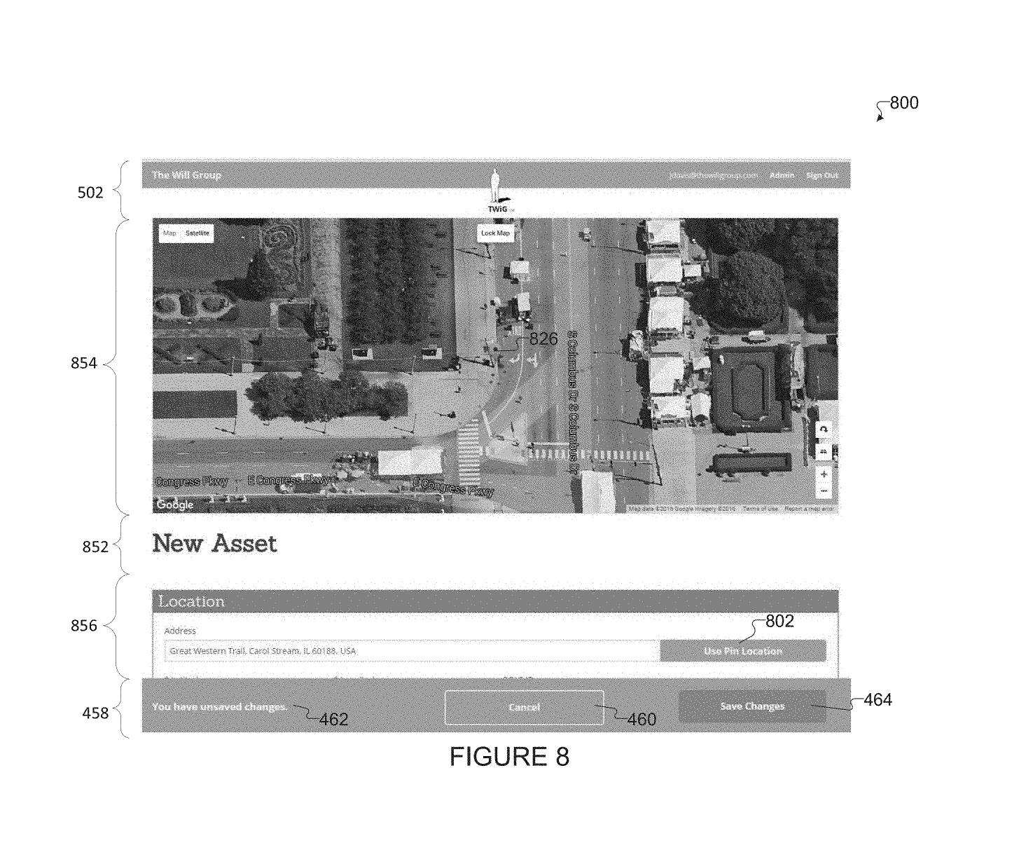

The function menu section 406 includes a title 420 of the currently selected function within the survey tool 120, which is “Search Address” in the display screen 400. The function menu section 406 also includes one or more tabs, such as the “Search” tab 422 and “New Asset” tab 424. As shown, the “Search” tab 422 is currently selected, which causes the survey tool 102 to display the GUI according to a “Search Address” function. The query results are displayed in the tabular query results section 408, below the function menu section 406. When the “New Asset” tab 424 is currently selected, the survey tool 120 generates another display screen 800 of a GUI according to a “New Asset” function, as described in further detail with reference to FIG. 8.

In certain embodiments, the tabular query results section 408 include a table of query results of the assets nearest the determined center point of the geographical area currently displayed. For example, the table in the tabular query results section 408 can include a first row, such as a heading row for identifying the field of each column, and can include a subsequent row for each record in the query results. In the example shown, the columns include a “Distance” column, a “Nearest Assets” column, a “Wattage” column, and a “Status” column, each of which corresponds to a field in each asset record in the asset survey database 126.

As shown in the example shown in FIG. 4B, the tablet computer 414 displays a display screen 450 of a GUI according to, and in response to, an “Edit Asset” function within the survey tool 120. The GUI according to an “Edit Asset” function includes a heading section 402, which is hidden from view in the display screen 450 due to a scroll down operation. The GUI according to an “Edit Asset” function includes a title section 452 of the currently selected function within the survey tool 120, namely, the title of “Edit Asset.” The GUI according to an “Edit Asset” function includes a map section 454, which can be displayed vertically above the title 452, shows a satellite view of a geographical area surrounding a reference point 426. The GUI according to an “Edit Asset” function includes a location section 456, and a save data section 458. The save data section includes a cancel button 460 for deleting unsaved changes, a data saving status 462 indicating whether user-inputted content to a content control is saved in the asset inventory survey database 122 or unsaved (for example, “You have unsaved changes”), and a save changes button 464 for saving user-inputted content. Additional sections could be included (that is, displayed) in the display screen 450 according to the “Edit Asset” function. For example, the “Edit Asset” function of the survey tool 120 includes an installation function and the punch list function. The installation function enables the survey tool 120 to add new equipment fields linked to previously stored location fields of an asset record, which corresponds to the work of field personnel who installed a new light fixture on a pole at the location identified by the previously stored location fields of the asset record. A punch list function enables the survey tool 120 to add verification fields linked to an asset record, which corresponds to the work of field personnel who confirmed that the field values within an asset record matches the physical asset installed in the field.

FIG. 5 illustrates an initial logged-in screen 500 according to this disclosure. In the example shown, the initial logged-in screen 500 includes the GUI according to a “Search Address” function. Note that sections 502, 504, 506, and 508 in FIG. 5 could be the same as or similar to corresponding sections 402, 404, 406, and 408 in FIG. 4A. These sections in FIG. 5 can operate in the same or similar manner as the corresponding sections in FIG. 4A and can incorporate components 410, 412, 416, 418 from the corresponding sections in FIG. 4A.

In the heading section 502, the user name 416 could include an email address 516a and a user account privilege level 516b of the logged-in user authorized to access the asset survey database 126. For example, the user account privilege level 516b could include “Admin” for an administrator of the web-based application of the survey tool 120. The user account privilege levels 516b can include a different level for personnel who surveys infrastructure onsite in the field; or can include a third different level for personnel member of the asset owner who can review, search, and coordinate survey work of field users. Each authorized user record can include a user account privilege level field.

The map section 504 shows geographical map view of a geographical area and shows a set of geospatial pins. In the specific initial logged-in screen 500 shown, the survey tool 120 determines the reference point according to a center point of the geographical area currently displayed in the map section 504, as indicated by the “Center Map” mode 526. The set of geospatial pins correspond to an initial query result. In certain embodiments, the initial query result includes asset records that can be edited by the logged in user name 416. When the logged in user name 416 belongs to an administrator of the web-based application of the survey tool 120, the initial query result includes either asset records of a user-selected subset of asset owners, or alternatively, all of the asset records (of all asset owners) within the geographical area currently displayed in the map section 504.

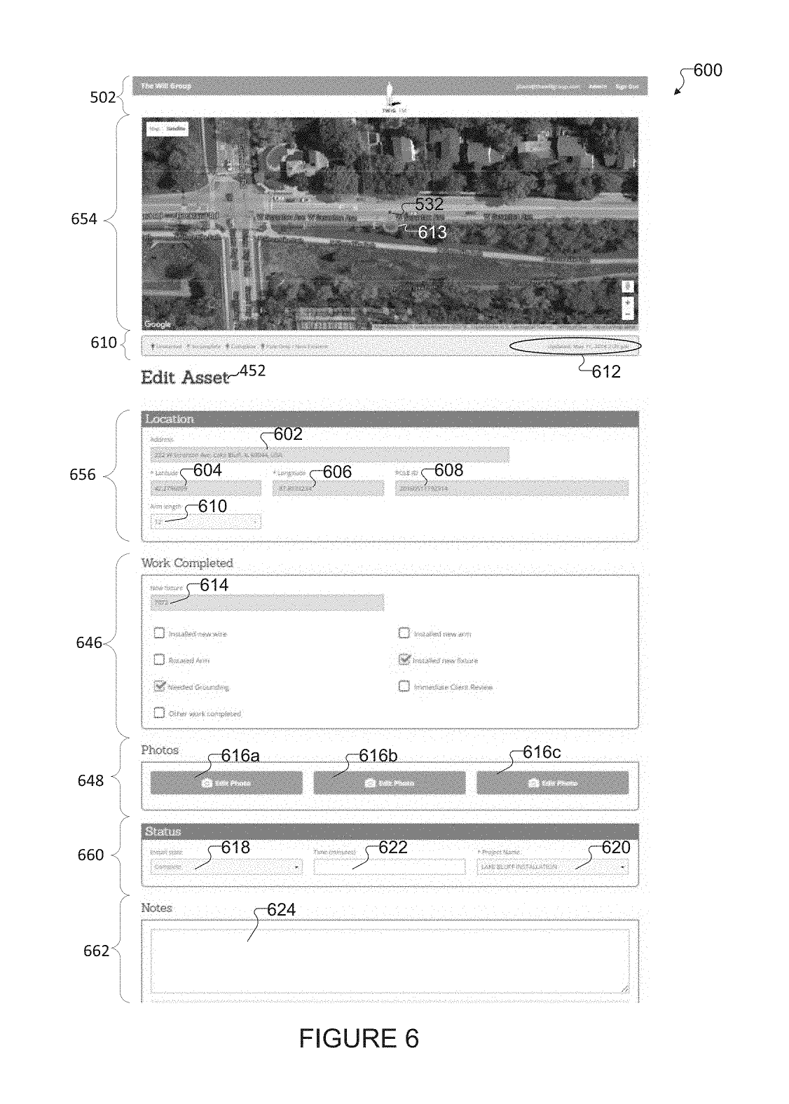

Below the map section 504, the initial logged-in screen 500 includes a legend section 510, which visually distinguishes each geospatial pin based on a completion progress of the an asset record to which the geospatial pin corresponds. The completion progress (shown as install state 618 in FIG. 6) of an asset record can be either “Unstarted” (represented by a pin 528 in a first color, such as red), “Incomplete” (represented by a pin 530 in a second color, such as yellow), “Complete” (represented by a pin 532 in a third color, such as green), or “Pole Only/Non Existent” (represented by a pin 534 in a fourth color, such as grey).

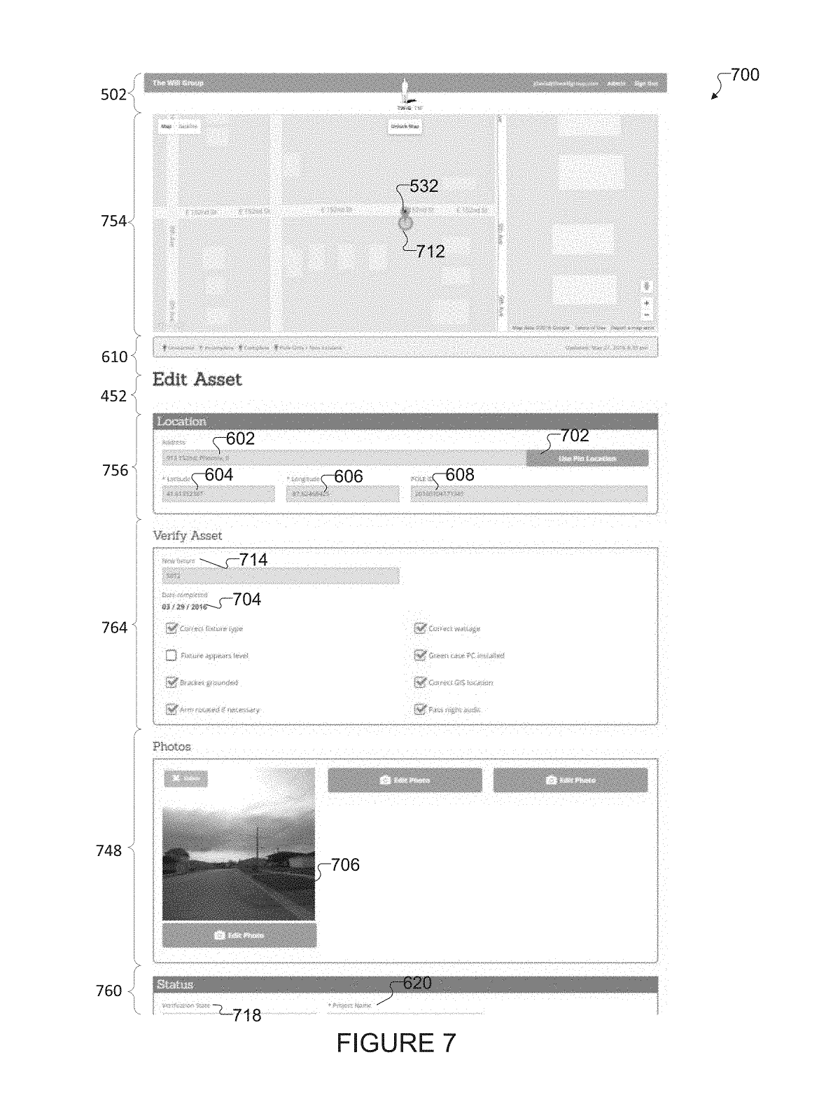

The function menu section 506 includes a title 420 of the currently selected function within the survey tool 120, which is “Search Address” in the initial logged-in screen 500. The function menu section 506 also includes one or more tabs, such as the “Search” tab 422, and “New Install” tab 524 and “New Survey” tab 536. As shown, the “Search” tab 422 is currently selected, which causes the survey tool 102 to display the GUI according to a “Search Address” function. When the “New Install” tab 524 is currently selected, the survey tool 120 generates another display screen 600 of a GUI according to an installation function within the survey tool 120, as described in further detail with reference to FIG. 6. When the “New Survey” tab 536 is currently selected, the survey tool 120 generates another display screen 800 of a GUI according to a punch list function within the survey tool 120, as described in further detail with reference to FIG. 7.

The query results are displayed in the tabular query results section 508, below the function menu section 506. In the example, shown, the columns include a “Distance” column 538, an “Assets” column 540, a “Pole ID” column 542, and a “Status” column 544, each of which corresponds to a field in each asset record in the asset survey database 126.

FIG. 6 illustrates a display screen 600 of a GUI according to an installation function of the survey tool 120 according to this disclosure. As described above, the installation function enables the survey tool 120 to add new equipment fields linked to previously stored location fields of an asset record, which corresponds to the work of field personnel who installed a new light fixture on a pole at the location identified by the previously stored location fields of the asset record.

Note that the display screen 600 includes the heading section 502 of the initial logged-in screen 500 in FIG. 5, and could include the title section 452 of the currently selected function within the survey tool of FIG. 4B. Note that location section 656 and the legend section 610 in FIG. 6 could be the same as or similar to corresponding location section 456 in FIG. 4B and the legend section 510 in FIG. 5. These sections in FIG. 6 can operate in the same or similar manner as the corresponding sections in FIGS. 4B and 5.

The GUI according to the installation function includes a map section 654, which can be displayed between the heading section 502 and legend section 510. The GUI according to the installation function includes a work completed section 646, a photos section 648, a status section 660, and a notes section 662. Additional sections could be included (namely, displayed) in the display screen 600 according to the installation function. For example, a scroll operation may cause a save data section 458 to be displayed. When field personnel completes installation of an asset and inputs corresponding content to the fields displayed in the display screen 600, the survey tool 120 records an updated time 612, which can be the date and time at which the installation work is completed or at which the logged-in user saves the user-inputted data.

The location section 656 includes multiple content controls, including text boxes and drop-down lists for various location field values. In the example shown in FIG. 6, the location section 656 includes a text boxes for fields of each of: a street address 602, latitude coordinate 604, longitude coordinate 606, a pole identification (ID) number 608. Also, the location section 656 includes a drop-down list for an arm length 610 field value, which could contain a list of standardized lengths of pole arms, such as 12 feet.

In certain embodiments, the installation function enables the web-based application of the survey tool 120 to block a logged-in user from editing the location section 656 while allowing the logged-in user to view the location field values. The life cycle of a lighting fixture, light bulb, or other equipment mounted to a pole is generally shorter than the life cycle of the pole, accordingly, once the location field values have been verified for the pole, the asset owner can set the survey tool 120 to block further edits to the verified location field values.

The map section 654 shows a satellite view of a geographical area surrounding a complete pin 532, which could represent a pole, which is the asset installed at the location identified by the location section 656. The survey tool 120 can generate a circle of geospatial area surrounding the complete pin 532 as a reference point 613, and the circle can have a fifth color (for example, blue) to visually distinguish the encircled area from the first through fourth colors of the various pins 532, 534, 536, 538.

The work completed section 646 includes multiple content controls for various work completed field values, including a text box for a new fixture identification 614 and multiple check-boxes for each work task that may be completed at the pole located at the location identified by the location section 656. Examples of completed work tasks include: installed new wire; rotated arm; needed grounding; installed new arm; installed new fixture; immediate client review; and other work completed. In the particular example shown, user input indicates that the work completed includes needed grounding and installed new fixture having the new fixture identification 614 (e.g., “70T2”).

The photos section 648 displays a number thumbnails of photographs of the asset installed at the location identified by the location section 656. The photo section 648 also includes an edit photo button 616a-616c for each thumbnail. In certain embodiments, upon detecting that one of the edit photo buttons 616a-616c has been touched, the survey tool 120 controls a camera built-in the UE 300 to capture a picture of the asset of interest, and automatically generates a relationship link from the new captured picture to the assets of interest.

The status section 660 includes multiple content controls for various status field values, including a drop-down list for install state 618 and project name 620, and a time 622 text box for minutes elapsed in order to complete the work tasks indicated as completed in the work completed section 646. The install state 618 can indicate whether the installation of assets at the location identified by the location section 656 is unstarted, incomplete, complete, or whether no assets and/or no pole are installed at the location identified by the location section 656. The survey tool 120 uses the field value of the install state 618 to determine the color of the pin 532 shown in the map section 654.

The notes section 662 includes a notes text box 624, into which a user can input comments regarding the assets installed at the location identified by the location section 656.

FIG. 7 illustrates a display screen 700 of a GUI according to the punch list function of the survey tool 120 according to this disclosure. As described above, the punch list function enables the survey tool 120 to add verification fields linked to an asset record, which corresponds to the work of field personnel who confirmed that the field values within an asset record matches the physical asset installed in the field.

Note that the display screen 700 includes the heading section 502 of the initial logged-in screen 500 in FIG. 5, includes the legend section 610 of FIG. 6, and could include the title section 452 of the currently selected function within the survey tool of FIG. 4B. Note that location section 756, a photos section 748, and a status section 760 in FIG. 7 could be the same as or similar to corresponding location section 456 in FIG. 4B, and corresponding sections 648 and 660 of FIG. 6. These sections in FIG. 7 can operate in the same or similar manner as the corresponding sections in FIGS. 4B and 6.

The GUI according to the punch list function includes a map section 754, which can be displayed between the heading section 502 and legend section 510. The GUI according to the punch list function includes a verify asset section 764. Additional sections could be included (that is, displayed) in the display screen 700 according to the punch list function. For example, a scroll operation may cause a save data section 458 to be displayed. When field personnel completes verification of an asset and inputs corresponding content to the fields displayed in the display screen 700, the survey tool 120 records an updated time 612, which can be the date and time at which the verification work is completed or at which the logged-in user saves the user-inputted data for updating the asset inventory survey database 122.

The map section 754 shows a geographical map view of a geographical area surrounding a complete pin 532 that represents a pole, which is the being asset verified as having been installed at the location identified by the location section 756. In this example, the complete pin 532 is also the reference point of the map section 754. The survey tool 120 can generate a circle of geospatial area surrounding the complete pin 532 as a reference point 712, and the circle can have a fifth color (for example, blue) to visually distinguish the encircled area from the first through fourth colors that represent the install state 618.

The location section 756 includes a use pin location button 702. For example, an asset owner may possess a document that indicates that a pole is located at a first location, and desire a field technician verify the actual location of that pole. A field technician may carry the tablet computer 414 to the first location, looking for that pole, and can observe whether the pole is installed at the first location. More particularly, while the tablet computer 414 is located at the actual location of the pole, the survey tool 120 can use a GPS capability of the tablet computer 414 to determine the geographic coordinates of the current location of the tablet computer 414, which would be the same as the actual location of the pole. If the actual location of the pole is different from the first location, the field technician, as a logged-in user, uses the location section 756 to update location fields of the asset record corresponding to that pole. The punch-list function enables the survey tool 120 to detect a touch on the use pin location button 702, and in response, change the location field values to match the geographic coordinates of the current location of the tablet computer 414. Also, the punch-list function enables the survey tool 120 to receive user input location field values into the location section 756 to update location fields of the asset record corresponding to that pole.

The verify asset section 764 displays a verification date completed field value 704, which can be the same dated of the updated time 612. The verify asset section 764 includes multiple content controls for various verify asset field values, including a text box for a fixture identification 714 (for example, “50T2”) and multiple check-boxes for each asset verification task that may be completed at the pole located at the location identified by the location section 756. Examples of asset verification tasks include: correct fixture type; fixture appears level; bracket grounded; arms rotated if necessary; correct wattage; green case PC installed; correct GIS location; and pass night audit.

The photos section 748 displays a number thumbnails of photographs of the asset installed at the location identified by the location section 756. In addition to the edit photo buttons 616a-616c for each thumbnail, the photo section 748 also includes a thumbnail 706 that is a photograph of the pole located at the location identified by the location section 756.

The status section 760 includes multiple content controls for various asset verification status field values, including a drop-down list for verification state 718 and project name 620. In certain embodiments, the status section 760 could additionally include and a time text box for minutes elapsed in order to complete the asset verify tasks indicated as completed in the verify asset section 764. The verification state 718 can indicate whether the verification of assets at the location identified by the location section 756 is unstarted, incomplete, complete, or whether no assets and/or no pole are installed at the location identified by the location section 656. In certain embodiments, the survey tool 120 uses the field value of the verification state 618 to determine the color of the pin 532 shown in the map section 754.

FIGS. 8-15 illustrate examples of a display screen that is a partial portion of the entire GUI according to a “New Asset” function of the survey tool 120 according to this disclosure. A scrolling operation can cause the tablet computer 414 to display various portions the GUI according to a “New Asset” function. As a specific example, an entity, which does not have an inventory of the assets owned or does not have information about the location and/or condition of the assets that are in service in the field, can perform a survey process by using the “New Asset” function of the survey tool 120. For example, the survey process can include recording a GIS location, location data, and equipment data; obstructions and review flagging; photographing assets; tracking the status of completion of the survey process; and noting comments. As described more particularly below, the “New Asset” function enables the survey tool 120 to generate a new asset record for each asset subjected to the survey process. The new asset record includes various fields, which receive field values through the various sections of the GUI according to a “New Asset” function.

FIG. 8 illustrates a display screen 800 of a GUI according to the “New Asset” function of the survey tool 120 according to this disclosure. The GUI according to the “New Asset” function includes the heading section 502 of the initial logged-in screen 500 in FIG. 5, and includes the save data section 458 of FIG. 4B. The GUI according to the “New Asset” function includes a map section 854, a title section 852, and location section 856, which could operate in a same or similar manner as corresponding sections 754, 452, 756, of FIGS. 7 and 4B.

The map section 854 shows a satellite view of a geographical area surrounding a reference point 826. In this example, an unstarted pin represents the reference point of the map section 854, and represents the geographic location of an asset (e.g., pole and/or light fixture) for which a new asset record is being created. In the asset record, in order to add field values for the street address and/or geographic coordinates of the actual location of the asset of interest, the survey tool 120 could detect touch input to the tablet computer 414 placing the unstarted pin on the map, at location representing the actual location of the asset of interest. Alternatively, the survey tool 120 could detect a touch on the use pin location button 802, and in response, add location field values to match the geographic coordinates of the current location of the tablet computer 414. As another example, the survey tool 120 could detect user input of text into text boxes for fields of each of: a street address 602, latitude coordinate 604, longitude coordinate 606, a pole identification (ID) number 608.

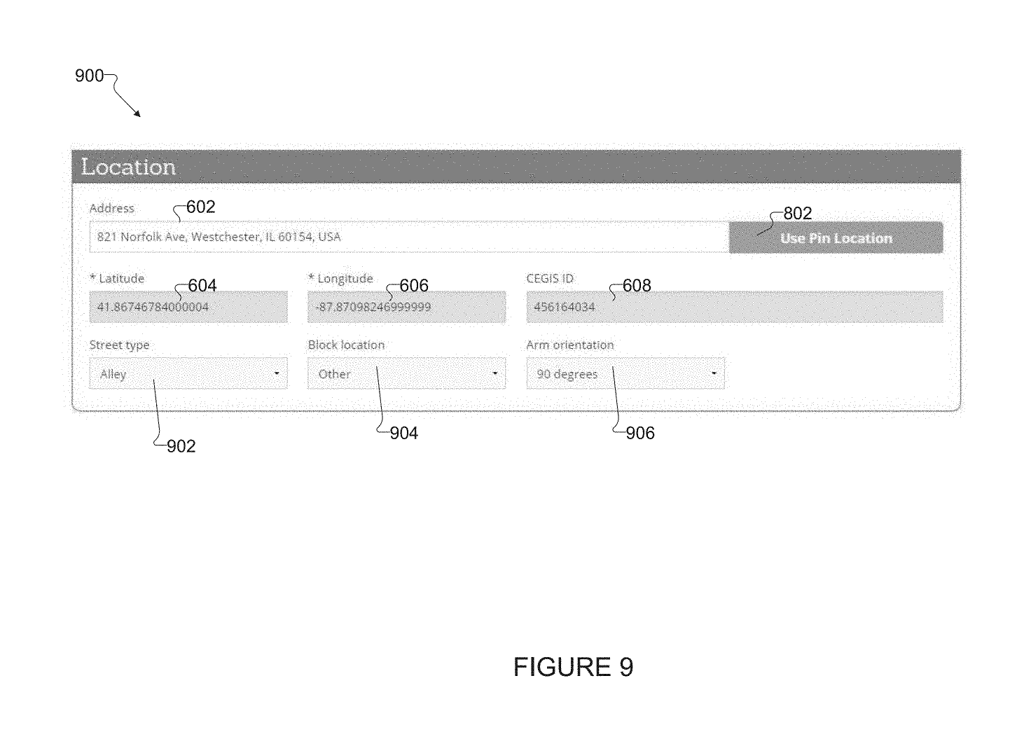

FIG. 9 illustrates an example location section 900 of a GUI generated by the survey tool according to this disclosure. Note that the location section 900 could be displayed in the GUIs according to a “Search Address” function, “New Asset” function, “Edit Asset” function (including the installation function and the punch list function) of FIGS. 4A-4B, 5, 6, 7, and 8. The location section 900 includes multiple content controls (for example, text boxes and drop-down lists) for various location field values: a street address 602, latitude coordinate 604, longitude coordinate 606, a pole identification (ID) number 608 (e.g., CEGIS ID), street type 902 (such as, alley, or major road), block location 904, (for example, other, or intersection), and arm orientation 906 (e.g., 90 degrees). Also note that the location section 900 could include the use pin location button 802 of the display screen 800 of FIG. 8.

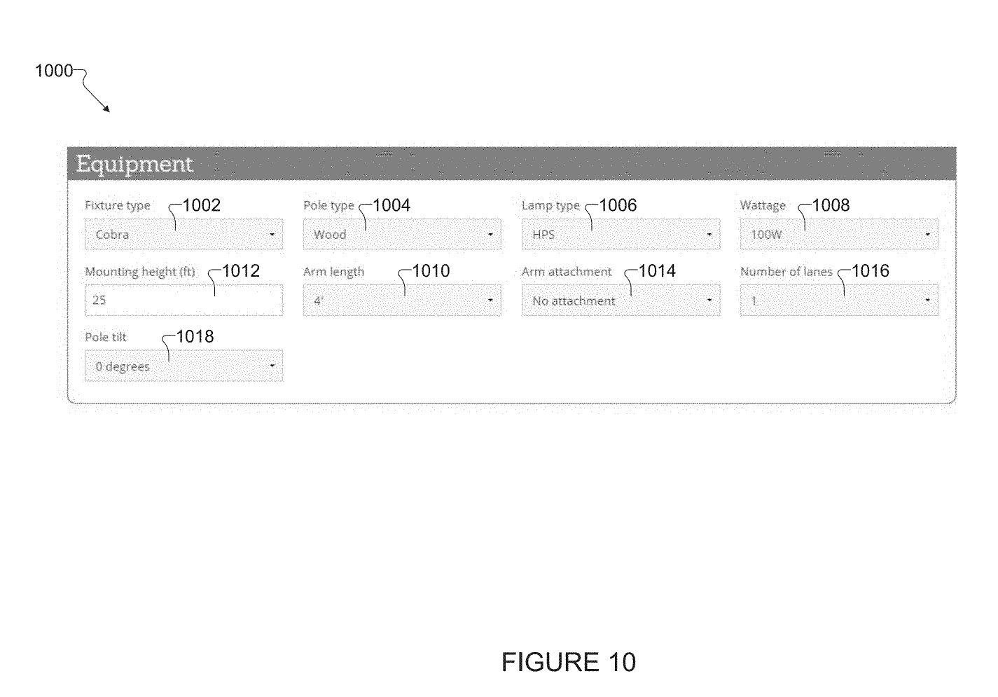

FIG. 10 illustrates an example equipment section 1000 of a GUI generated by the survey tool according to this disclosure. The equipment section 1000 enables the survey tool 120 to receive equipment field values that provide a detailed description of an asset installed at a particular location. Note that the equipment section 1000 could be displayed in the GUIs according to a “Search Address” function, “New Asset” function, “Edit Asset” function (including the installation function and the punch list function) of FIGS. 4A-4B, 5, 6, 7, and 8.

The equipment section 1000 includes multiple content controls (for example, drop-down lists) for various equipment field values, including: a fixture type 1002 (for example, cobra), pole type 1004, lamp type 1006 (such as, high pressure sodium (HSP) light bulb), lamp wattage 1008 (such as 100, or 250), arm length 1010, mounting height 1012, arm attachment arm 1014, number of lanes 1016, and pole tilt 1018. The equipment field value for fixture type 1002 could identify a manufacture name, model name, or light fixture design type. The equipment field value for pole type 1004 could identify material of the pole, such as wood, metal, concrete and the like. The equipment field value for arm length 1010, which could be the same as or similar to the arm length 610 field value of FIG. 6. The equipment field value for mounting height 1012 could include a text box user input for the height at which the arm is mounted to the pole. The equipment field value for arm attachment 1014 could identify whether or not an arm is attached to the pole. The equipment field value for number of lanes 1016 could indicate the number of lanes for vehicles on the street of the street address 602. The equipment field value for pole tilt 1018 could indicate an angle between the ground and the pole.

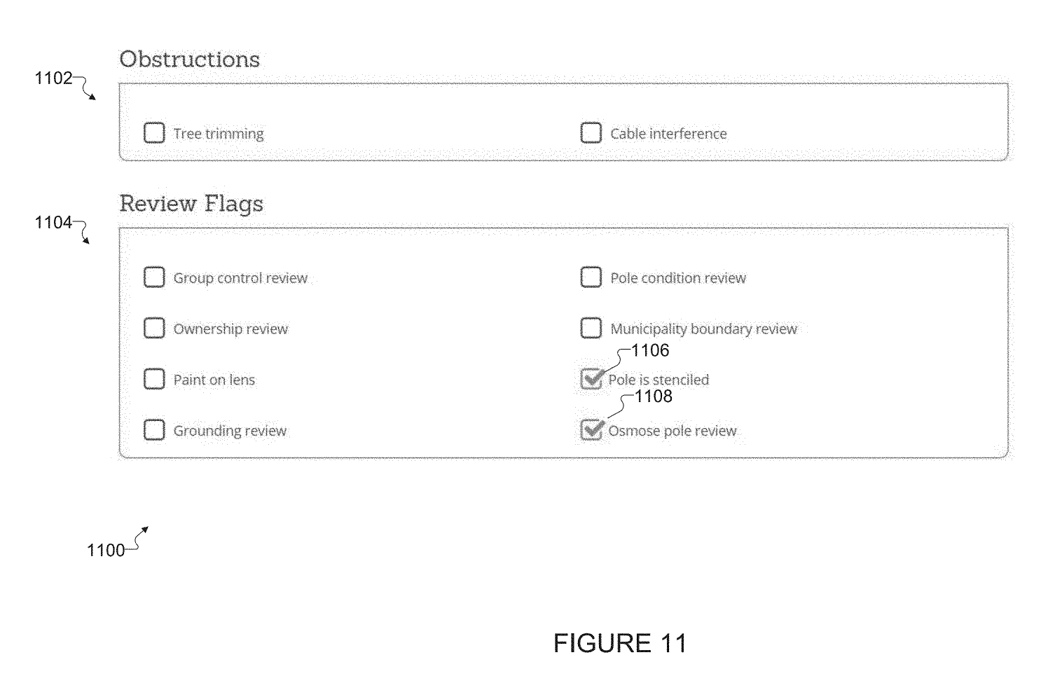

FIG. 11 illustrates an example of display screen 1100 of a section 1102 of obstructions flags and a section 1104 of review flags according to this disclosure. The obstructions and review flags sections 1102 and 1104 could be displayed in the GUIs according to a “Search Address” function, “New Asset” function, “Edit Asset” function (including the installation function and the punch list function) of FIGS. 4A-4B, 5, 6, 7, and 8.

The section 1102 of obstructions flags includes multiple content controls (for example, check boxes) for obstruction field values, including check boxes for tree trimming 1102 and for cable interference 1104. A field technician may experience obstructions inhibiting access to a pole or light fixture infrastructure, and may touch one or more of the check boxes for tree trimming 1102 and for cable interference 1104. The survey tool 120 can detect user input to the check boxes for tree trimming 1102 and for cable interference 1104, and generate a corresponding GUI with checked or unchecked boxes. An asset owner may view the display screen 1100 to see whether the asset of interest has a need for tree trimming or clearing of cable interference.

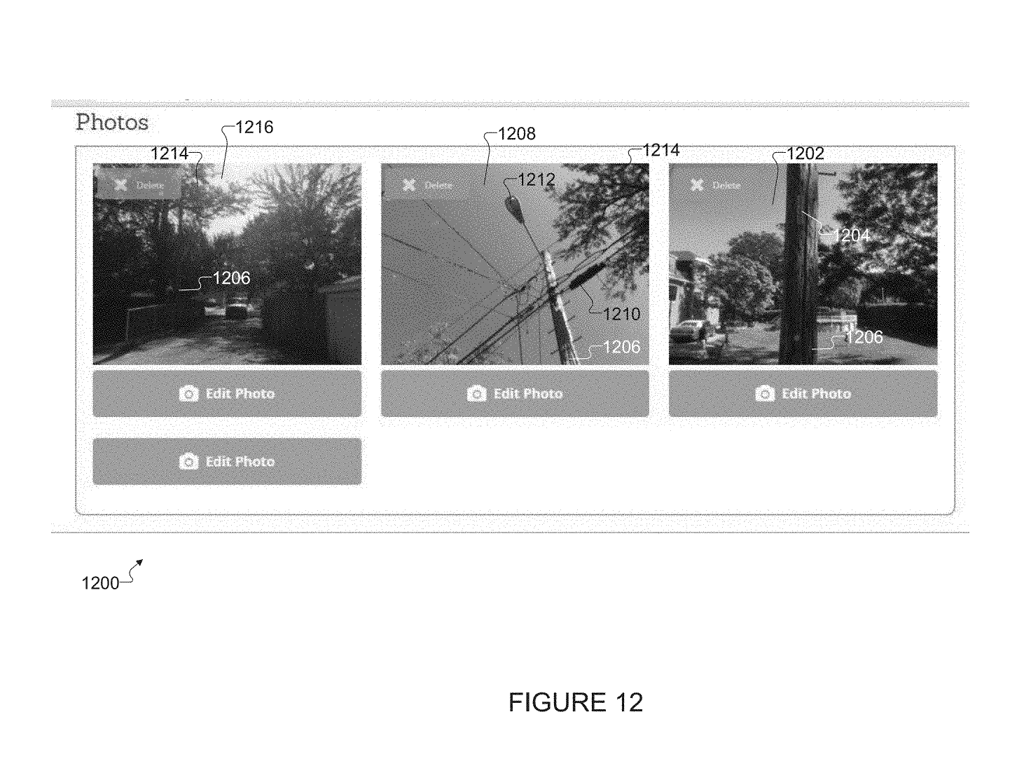

The section 1104 of review flags includes multiple content controls for review flag field values, such as a check box for each of: group control review; ownership review; paint on lens; grounding review; pole condition review; municipality boundary review; pole is stenciled; and osmose pole review. The survey tool 120 can detect user input to one or more of the check boxes in the section 1104 of review flags, which allows an asset owner view feedback from a field technician regarding what specific follow-up review work is needed at a particular location for an asset of interest. In the specific example shown, boxes are checked for pole is stenciled 1106 and pole review 1108. Correspondingly, the photo section 1200 shown in FIG. 12 includes a thumbnail 1202 image of a stencil 1204 on a wood pole 1206 (as indicated by pole type 1004) and a close-up view of the condition of the wood pole 1206 from the pole review.

FIG. 12 illustrates a photo section 1200 according to this disclosure. The photo section 1200 is similar to the corresponding photo section 748 in FIG. 7. In addition to the thumbnail 1202 described above, the photo section 1200 includes a thumbnail 1208 image of tree branches and foliage 1214 nearby the pole 1206 and cables 1210, which are mounted to the pole 1206 nearby the mounting location of the light fixture 1212 such that the cables 1210 interfere with accessing the light fixture 1212. The thumbnail 1208 could correspond to a case in which cable interference and tree trimming are flagged (such as by a checked box) in the section 1102 of obstructions flags. The photo section 1200 includes a thumbnail image 1216 of a one-lane alley, which could correspond to the street type 902 location field value of FIG. 9 and the equipment field value for number of lanes 1016 of FIG. 10.

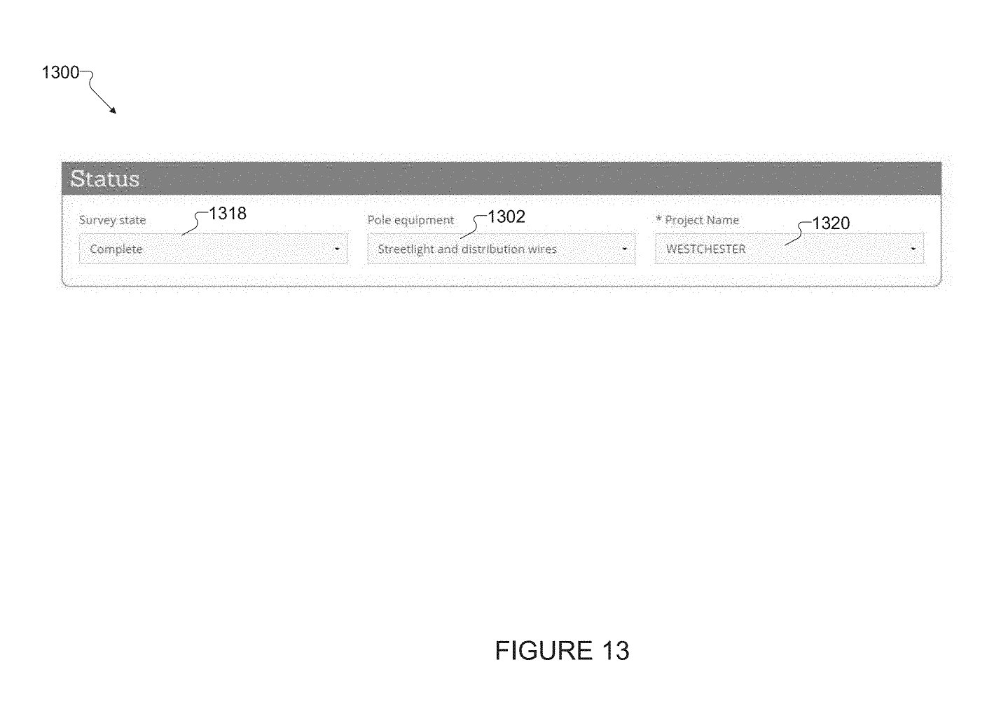

FIG. 13 illustrates a status section 1300 of a GUI according to the “New Asset” function according to this disclosure. Note that the status section 1300 can be similar to the status sections 660 and 760 of FIGS. 6 and 7. The status section 1300 includes multiple content controls for various status field values, including a drop-down list for pole equipment 1302, survey state 1318, and project name 1320. Note that the survey state 1318 can indicate whether the survey of assets at the location identified by the location section 900 is unstarted, incomplete, complete, or whether no assets and/or no pole are installed at the location identified by the location section 900. For example, the status field value for pole equipment 1302 could include a value such as “streetlight and distribution wires,” or other value indicating a summary of equipment mounted to the pole of interest (such as the pole 1206 shown in the thumbnail 1216 of FIG. 12).

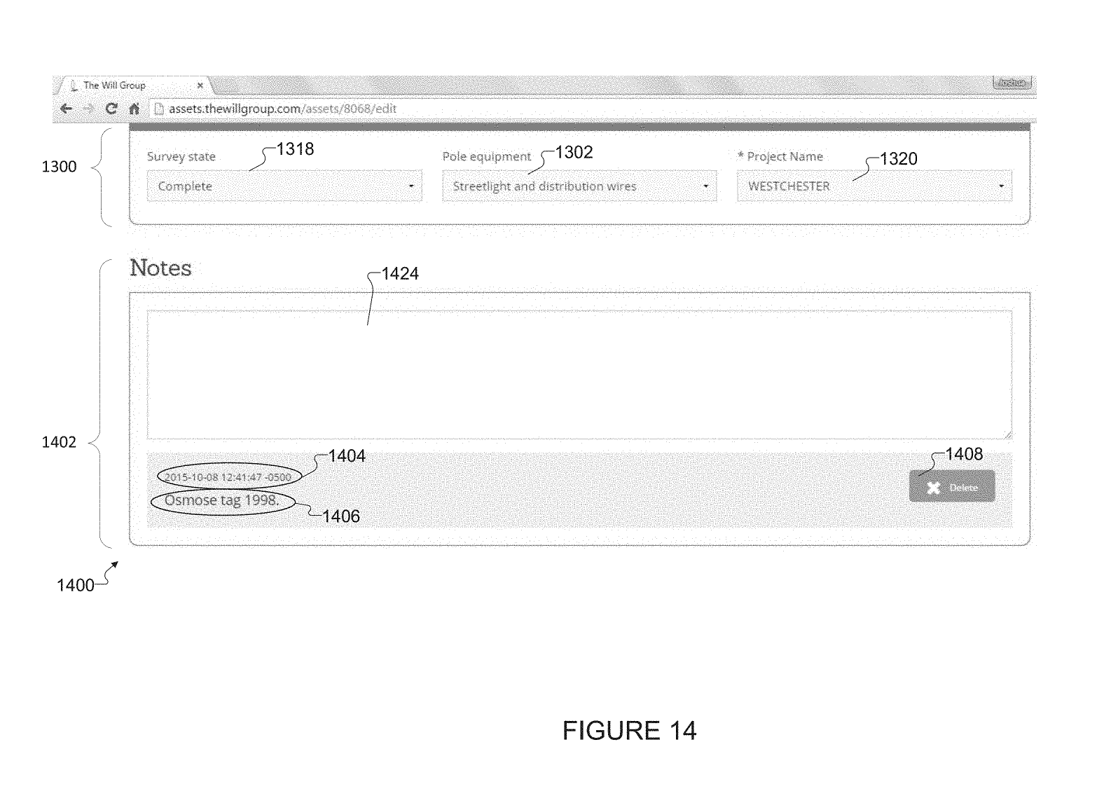

FIG. 14 illustrates a display screen 1400 showing a notes section 1402 of the GUI according to the “New Asset” function of the survey tool 120 according to this disclosure. As an example, the display screen 1400 shows the GUI according to the “New Asset” function via a web browser. The notes section 1402 could be the same as or similar to the notes section 662 of FIG. 6, and could include the similar components, such as a notes text box 1424, into which a user can input comments regarding the assets surveyed at the location identified by the location section 900. The survey tool 120 records a creation time 1404, which can be the date and time at which the survey work is completed or at which the logged-in user saves the user-inputted data or notes. The notes section 1402 includes a tag identification 1406, which could be a tag identification of a pole review 1108. The notes section 1402 includes a delete button 1408 for the text inputted to the notes text box 1424.

Although FIGS. 8-14 illustrate examples of display screens of various sections of the GUI according to a “New Asset” function of the survey tool 120, various changes may be made to FIGS. 8-14. For example, the save data section 458 may be continuously displayed at the bottom of the display screen, while a scroll operation shows and hides other sections.

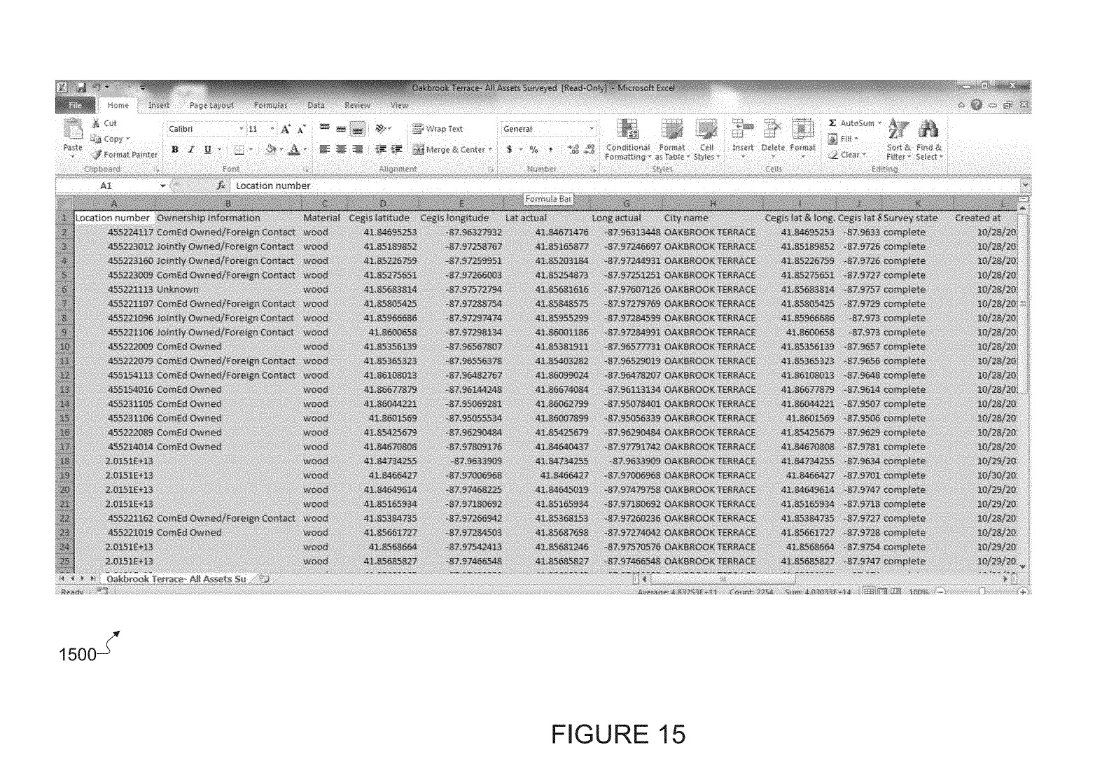

FIG. 15 illustrates a display screen of a comma separated value (CSV) data export 1500 of multiple records from the asset inventory survey database 122 according to this disclosure. In the example shown the data export could be a CSV file, or other tabular-data-to plain-text conversion type file, which can be opened or viewed through a spreadsheet application or a database application. The survey tool 120 can filter the asset inventory survey database 122 such that the CSV data export 1500 includes asset records that meet specified criteria.

In the example shown, the specified criterion is a specified city name (e.g., “Oakbrook Terrace”). The survey process caused the survey tool 120 to create thousands of asset records. In the display screen of the CSV data export 1500, each row represents a respective asset record, and each column represents fields within the asset records. For example, an asset record could include field values for: a location number (column A) such as in pole ID number 608; ownership information (column B); material (column C) such as pole type 1004; CEGIS latitude (column D) such as latitude coordinate 604; CEGIS longitude (column E) longitude coordinate 606; actual latitude coordinate (column F); actual longitude coordinate (column G); city name (column H) such as provided in street address 602; CEGIS latitude and longitude X (column I); CEGIS latitude & longitude Y (column J); survey state (column K) as in survey state 1318; and creation date (column L) such as creation time 1404.

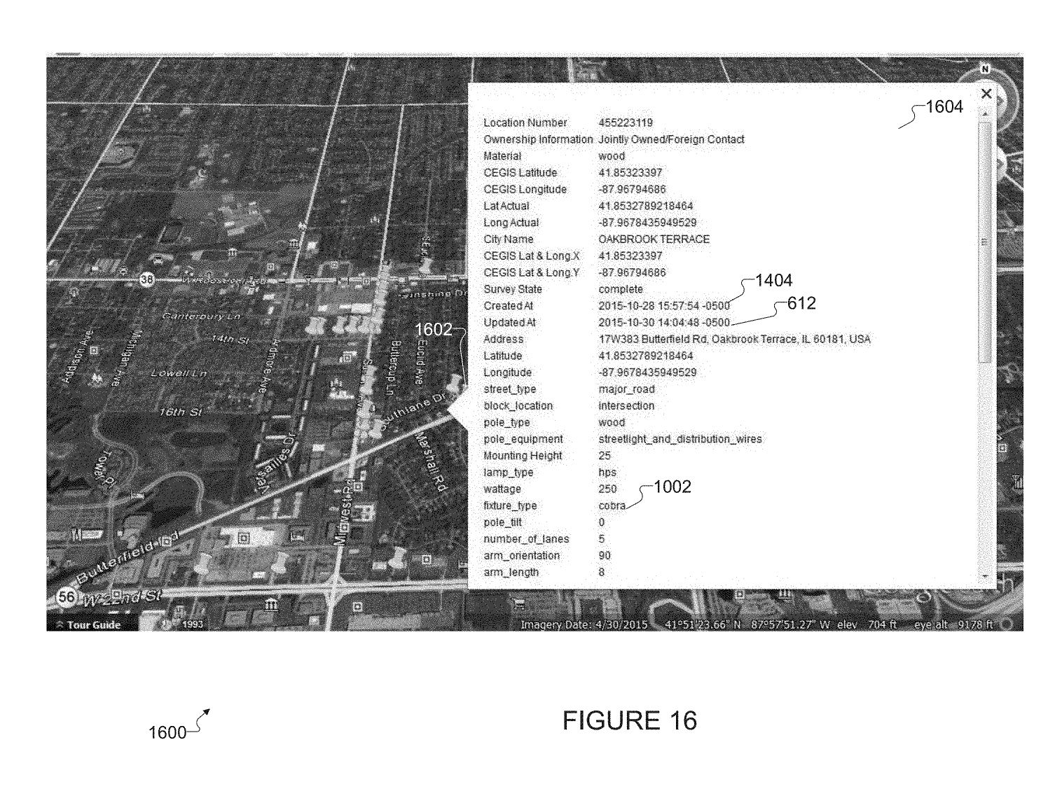

FIG. 16 illustrates a display screen of a Keyhole Markup Language (KML) data export 1600 of multiple records from the asset inventory survey database 122 according to this disclosure. In the example shown the KML data export 1600 could be a KML file, which can be opened or viewed through an Earth browser application, such as GOOGLE® Earth, GOOGLE® Maps. In the example shown, geospatial pins (shown as thumbtacks) represent each asset record that meets specified criteria, such as city name of “Oakbrook Terrace.” In the example shown, the KML data export 1600 is opened in an Earth browser application, and the set of geospatial pins are shown on a satellite view map at locations specified by the location field values in the respective exported asset records.

As a specific example, when a user selects one of the geospatial pins 1602, a corresponding popup or bubble 1604 may show the field names and field values from the asset record. For example, the bubble 1604 includes a location number, ownership information, material, CEGIS latitude, CEGIS longitude, actual latitude, actual longitude, city name, CEGIS latitude and longitude X, CEGIS latitude and longitude Y, survey state, creation date such as creation time 1404, updated time 612, street address, latitude, longitude, street type, block location, pole type, pole equipment 1302, mounting height, lamp type, lamp wattage, fixture type 1002, pole tilt, number of lanes, arm orientation, and arm length.

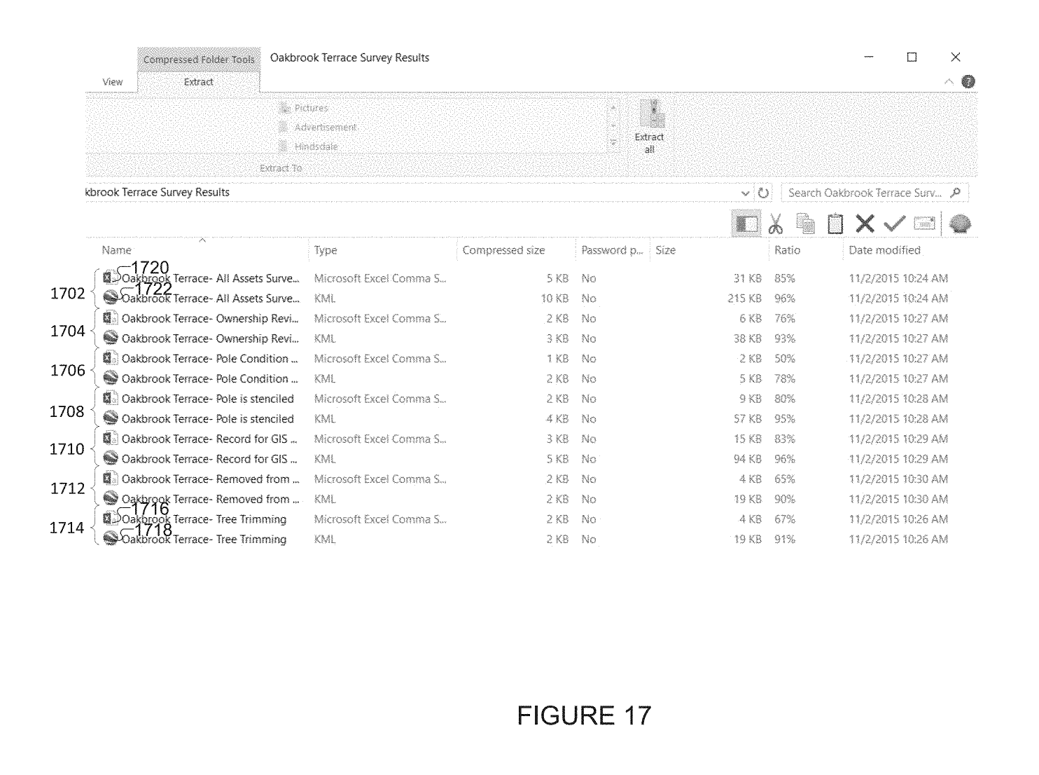

FIG. 17 illustrates various KML and CSV exports 1702, 1704, 1706, 1708, 1710, 1712, and 1714 by specific criteria according to this disclosure. Each of the KML and CSV exports 1702, 1704, 1706, 1708, 1710, 1712, and 1714 is generated by the survey tool 120 based on user inputted filtering criteria, and can be transmitted by the survey tool 120 to one or more client devices 106-114. In certain embodiments, the survey tool 120 provide one or more of the KML and CSV exports 1702, 1704, 1706, 1708, 1710, 1712, and 1714 to a computer readable medium (for example, flash memory storage device, compact disc, or the like), enabling user devices (such as, client device 1226-1215) to view information exported from the asset inventory survey database 122 offline, namely, without being currently connected to the survey tool 120 via the network 102.

As an example, the KML and CSV exports 1714 includes a CSV file 1716 and a KML file 1718, each file including asset records that meet specified criteria. In the example shown, the specified criteria are a specified city name (for example, “Oakbrook Terrace”) and tree trimming obstruction flagged at 1102. As another example, the KML and CSV exports 1702 include the CSV file 1720 according to the CSV data export 1500 and the KML file 1722 according to the KML data export 1600, in which cases the specified criteria is a specified city name (for example, “Oakbrook Terrace”) and all assets surveyed.

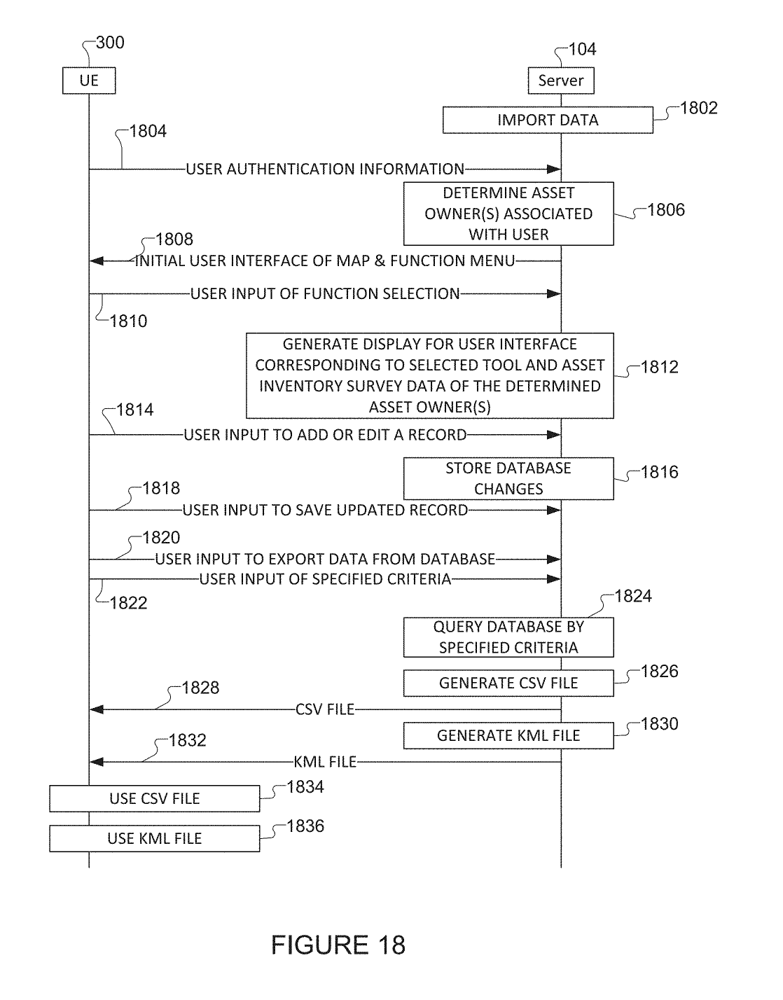

FIG. 18 illustrates a method 1800 for building an asset inventory survey database and generating a graphical user interface (GUI) including a display screen of information in the asset inventory survey database according to this disclosure. The method 1800 is implemented by the survey tool 120, such as at least one processor of the server 104 configured to perform the operations of the method 1800. In the example shown, the server 104 communicates with a UE 300, such as the tablet computer 414.

In operation 1802, the survey tool 120 imports preexisting data for creating one or more asset records. For example, the preexisting data could be imported from a document, file, or a preexisting database. The preexisting database could be provided by a particular asset owner. The survey tool 120 could receive a respective preexisting database from multiple asset owners. The survey tool 120 creates one or more asset records in the asset inventory survey database 122 using the imported data, and records a creation date in the created asset records. More particularly, selected field values of the imported dated are added to corresponding field values in the newly created asset record in the asset inventory survey database 122

In response to receiving user authentication information from the UE 300 in operation 1804, the survey tool 120 determines which particular asset owner(s) is associated with the received user authentication information in operation 1806. For example, the survey tool 120 determines that the received user authentication information matches the user authentication information in an authorized user record.

In operation 1808, the survey tool 120 generates and provides an initial GUI including a geographical map and menu of functions of the survey tool to the UE 300 for displaying. For example, the survey tool 120 provides the initial logged-in screen 500 of FIG. 5. Note that generating the initial logged-in screen includes generating an initial query result by querying the asset inventory survey database 122 to select asset records that are allowed to be displayed to the logged-in user. That is, the GUI includes a display of asset inventory survey data linked to the determined asset owner(s) as determined in operation 1806.

In operation 1810, the survey tool 120 receives user input (through the initial GUI) indicating a selection of one of the functions of the survey tool 120. For example, the received user input indicates a selection of one of: the “Search Address” function, “New Asset” function, “Edit Asset” function, the installation function, the punch list function, or data export function.

In operation 1812, the survey tool 120 generates a GUI corresponding to the selected one of the functions of the survey tool 120, and the GUI includes a display of asset inventory survey data linked to the determined asset owner(s) as determined in operation 1806. For example, the survey tool 120 could generate a GUI that includes the map section 504 (including asset records selected in the initial query result) and an additional section, which displays a content control configured to add or update a corresponding field value in the asset inventory survey database 122 using content inputted to the content control.

In operation 1814, the survey tool 120 receives user input through the GUI generated in operation 1812. The user input can indicate a selection to add or edit an asset record. As a specific example, the when the punch list function is selected, the survey tool 120 can detect a user touch selecting the reference point 712 of FIG. 7 from among the set of geospatial pins of the initial query result, and in response to the detection, query the asset inventory survey database 122 to select the asset record linked to the reference point 712 for editing. As another specific example, when the “New Asset” function is selected, the survey tool 120 can detect a user touch dropping a new geospatial pin at the reference point 826, and in response to the detection, add a new asset record that includes location field values corresponding to the reference point 826 of FIG. 8.

In operation 1814, the survey tool 120 can receive a series of user-inputted content to the various content controls of the GUI corresponding to the selected one of the functions of the survey tool, thereby adding or updating multiple field values in the selected asset record. In the example in which the punch list function is selected, the survey tool 120 can verify correctness of a certain field value corresponding to a characteristic of an asset owned by the determined asset owner(s) by receiving user input indicating that the certain field value is correct, such as a checking the correct asset fixture type checkbox in the verify asset section 764 of FIG. 7. The survey tool 120 can verify the correctness by alternatively receiving new content inputted to a content control linked to the certain field value, such as when the use pin location button 702 is touched.

In operation 1816, the survey tool 120 stores the database changes. In certain embodiments, the survey tool 120 can automatically save database changes in response to receiving user-inputted content to any one of the various content controls. In certain embodiments, the survey tool 120 can save database changes in response to receiving an indicator that the UE 300 has detected a user touch to the save changes button 464, as shown by operation 1818.

In operation 1820, the survey tool 120 receives user input to export data from the asset inventory survey database 122 to a CSV file, KML file, or both. In operation 1822, the survey tool 120 receives user input user input that specifies criteria for selecting which asset records will be exported. In operation 1824, survey tool 120 selects a set of asset records that store asset inventory survey data that meets specified criteria by querying the asset inventory survey database 122 using the specified criteria as a filter.

In operation 1826, the survey tool 120 generates a CSV file including the selected set of asset records that store asset inventory survey data that meets specified criteria. The survey tool 120 can output or otherwise store the CSV file in a computer readable medium. Also, as shown in operation 1828, the survey tool exports by transmitting the CSV file to the UE 300 via the network 102.

Similarly, in operation 1830, the survey tool 120 generates a KML file including the selected set of asset records that store asset inventory survey data that meets specified criteria. The survey tool 120 can output or otherwise store the KML file in a computer readable medium. Also, as shown in operation 1832, the survey tool transmits the KML file to the UE 300.

In block 1834, the UE 300 is able to use the exported CSV file both while connected to the network 102 and while offline. Similarly, in block 1836, the UE 300 is able to use the exported KML file both while connected to the network 102 and while offline.

Although various features have been shown in the figures and described above, various changes may be made to the figures. For example, the size, shape, arrangement, and layout of components shown in FIGS. 1 through 17 are for illustration only. Each component could have any suitable size, shape, and dimensions, and multiple components could have any suitable arrangement and layout. Also, various components in FIGS. 1 through 17 could be combined, further subdivided, or omitted and additional components could be added according to particular needs. Further, each component in a device or system could be implemented using any suitable structure(s) for performing the described function(s). In addition, FIG. 18 illustrates various series of steps, which could overlap, occur in parallel, occur multiple times, or occur in a different order.

Although embodiments of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. An apparatus, comprising:
a memory including a database configured to store asset inventory survey data of at least one asset owner; and
a processor configured to:
cause a remote terminal to display a graphical user interface (GUI) through an electronic display, wherein the GUI includes:
a geographical map,
a geospatial pin on the map at a location corresponding to a location field value of an asset record in the database, and
at least one content control configured to add or update at least one corresponding field value in the database using content inputted to the at least one content control,
determine that a user associated with a particular asset owner from among the at least one asset owner is authorized to access asset inventory survey data of the particular asset owner, and
based on the determination, display the asset inventory survey data of the particular asset owner in the GUI.

2. The apparatus of claim 1, wherein the processor is further configured to:
create the asset record based on imported data, and
update the asset record using content inputted to the at least one content control.

3. The apparatus of claim 1, wherein the processor is further configured to verify correctness of a certain field value corresponding to a characteristic of an asset owned by the at least one owner by:
receiving user input indicating that the certain field value is correct, or
alternatively, receiving new content inputted to a content control linked to the certain field value.

4. The apparatus of claim 1, wherein the processor is further configured to export the asset inventory survey data from the database to at least one of: a comma separated value (CSV) file, or a keyhole markup language (KML) file.

5. The apparatus of claim 4, wherein the processor is further configured to export the asset inventory survey data by:
selecting a set of asset records that store asset inventory survey data that meets specified criteria; and
exporting the selected set of asset records from the database.

6. The apparatus of claim 1, wherein the location field values include geographic coordinates of a location of an asset owned by the at least one asset owner.

7. The apparatus of claim 6, wherein the asset includes lighting fixture infrastructure.

8. A non-transitory computer readable medium embodying a computer program, the computer program comprising computer readable program code that, when executed by processing circuitry, causes the processing circuitry to:
store, in a database, asset inventory survey data of at least one asset owner;
execute a graphical user interface (GUI) through an electronic display, wherein the GUI includes:
a geographical map,
a geospatial pin on the map at a location corresponding to a location field value of an asset record in the database, and
at least one content control corresponding to at least one field value in the database;
add or update the at least one field value using content inputted to the at least one content control;
determine that a user associated with a particular asset owner from among the at least one asset owner is authorized to access asset inventory survey data of the particular asset owner; and
based on the determination, display the asset inventory survey data of the particular asset owner in the GUI.

9. The non-transitory computer readable medium of claim 8, wherein the computer program further comprises computer readable program code that, when executed by the processing circuitry, causes the processing circuitry to:
create the asset record based on imported data, and
update the asset record using content inputted to the at least one content control.

10. The non-transitory computer readable medium of claim 8, wherein the computer program further comprises computer readable program code that, when executed by the processing circuitry, causes the processing circuitry to:
verify correctness of a certain field value corresponding to a characteristic of an asset owned by the at least one owner by:
receiving user input indicating that the certain field value is correct, or
alternatively, receiving new content inputted to a content control linked to the certain field value.

11. The non-transitory computer readable medium of claim 8, wherein the computer program further comprises computer readable program code that, when executed by the processing circuitry, causes the processing circuitry to:
export the asset inventory survey data from the database to at least one of: a comma separated value (CSV) file, or a keyhole markup language (KML) file.

12. The non-transitory computer readable medium of claim 11, wherein the computer readable program code that when executed causes the at least one processing device to export the asset inventory survey data comprises computer readable program code that when executed causes the at least one processing device to:
select a set of asset records that store asset inventory survey data that meets specified criteria; and
export the selected set of asset records from the database.

13. The non-transitory computer readable medium of claim 8, wherein the location field values include geographic coordinates of a location of an asset owned by the at least one asset owner.

14. The non-transitory computer readable medium of claim 13, wherein the asset includes lighting fixture infrastructure.

15. A method comprising:
storing, in a database, asset inventory survey data of at least one asset owner;
executing a graphical user interface (GUI) through an electronic display, wherein the GUI includes:
a geographical map,
a geospatial pin on the map at a location corresponding to a location field value of an asset record in the database, and
at least one content control corresponding to at least one field value in the database;
adding or updating the at least one field value using content inputted to the at least one content control;
determining that a user associated with a particular asset owner from among the at least one asset owner is authorized to access asset inventory survey data of the particular asset owner; and
based on the determination, displaying the asset inventory survey data of the particular asset owner in the GUI.

16. The method of claim 15, further comprising:
creating the asset record based on imported data, and
updating the asset record using content inputted to the at least one content control.

17. The method of claim 15, further comprising:
verifying correctness of a certain field value corresponding to a characteristic of an asset owned by the at least one owner by:
receiving user input indicating that the certain field value is correct, or
alternatively, receiving new content inputted to a content control linked to the certain field value.

18. The method of claim 15, further comprising:
exporting the asset inventory survey data from the database to at least one of: a comma separated value (CSV) file, or a keyhole markup language (KML) file.

19. The method of claim 18, wherein exporting the asset inventory survey data comprises:
selecting a set of asset records that store asset inventory survey data that meets specified criteria; and
exporting the selected set of asset records from the database.

20. The method of claim 15, wherein:
the location field values include geographic coordinates of a location of an asset owned by the at least one asset owner, and
the asset includes lighting fixture infrastructure.
